(19) United States
(12) Patent Application Publication
(10) Pub. No.: US 2026/0100077 A1
(43) Pub. Date: Apr. 9, 2026

(54) DISPLAY CONTROL DEVICE, AND DISPLAY CONTROL METHOD

(71) Applicant: HONDA MOTOR CO., LTD., Tokyo (JP)

(72) Inventors: Ko Endo, Tokyo (JP); Naoki Kikuchi, Tokyo (JP); Shohei Kamochi, Tokyo (JP)

(21) Appl. No.: 19/339,511

(22) Filed: Sep. 25, 2025

(30) Foreign Application Priority Data
Oct. 7, 2024 (JP) 2024-175615

(51) Int. Cl. G07C 5/08; G06F 3/14

(52) U.S. Cl. CPC G07C 5/0825; G06F 3/14; G07C 5/0808

(57) ABSTRACT

A display control device that recognizes an execution status of an actuation check process for a predetermined function included in a movable object, the actuation check process being executed when the movable object is started; and that starts a warning display using a display device when the start operation of the movable object is recognized, and, when the actuation check process includes a first actuation check process of checking a normal operation of the predetermined function and a second actuation check process of checking whether option setting of the predetermined function is usable or unusable, the second actuation check process being executed after the first actuation check process checks the normal operation of the predetermined function, finishes the warning display at a point in time when recognizes that the normal operation of the predetermined function has been confirmed after the warning display is started.

### INCORPORATION BY REFERENCE

The present application claims priority under 35 U.S.C. § 119 to Japanese Patent Application No. 2024-175615 filed on Oct. 7, 2024. The content of the application is incorporated herein by reference in its entirety.

### BACKGROUND OF THE INVENTION

### Field of the Invention

The present invention relates to a display control device that controls actuation of a display device provided in a movable object, and a display control method.

### Description of the Related Art

Conventionally, a display device for a motor vehicle in which a plurality of warning lamps that warn of an abnormal state of each part of a motor vehicle are arranged has been known (e.g., refer to Japanese Patent Laid-Open No. 2003-146108). In the above-mentioned display device for a motor vehicle, the warning lamps are simultaneously turned on in conjunction with turning on an ignition switch of the motor vehicle, and the warning lamp corresponding to a part where no abnormality is detected is turned off, while the warning lamp corresponding to a part where an abnormality is detected remains on, thereby providing notification of the abnormality in the vehicle.

In recent years, as the functions of movable objects such as vehicles have become more advanced, the number of functional setting items has increased, and the time required for functional operation checks and initial settings tends to increase. Thus, as described above, when a warning display is started when the movable object is started and is turned off when it is confirmed that there is no abnormality in a target function, the waiting time until the warning display disappears increases, which may disadvantageously give a user riding in the movable object a feeling of anxiety.

The present invention has been made in view of the above background, and an object thereof is to provide a display control device that can reduce the time until a warning display displayed at the start of a movable object disappears.

### SUMMARY OF THE INVENTION

As a first aspect for achieving the above object, provided is a display control device that controls actuation of a display device provided in a movable object, the display control device including: a start operation recognition unit that recognizes a start operation of the movable object; an actuation check status recognition unit that recognizes an execution status of an actuation check process for a predetermined function included in the movable object, the actuation check process being executed when the movable object is started; and a warning display control unit that starts a warning display using the display device when the start operation recognition unit recognizes the start operation of the movable object, and finishes the warning display based on the execution status of the actuation check process recognized by the actuation check status recognition unit, in which when the actuation check process includes a first actuation check process of checking a normal operation of the predetermined function and a second actuation check process of checking whether option setting of the predetermined function is usable or unusable, the second actuation check process being executed after the first actuation check process checks the normal operation of the predetermined function, the warning display control unit finishes the warning display at a point in time when the actuation check status recognition unit recognizes that the normal operation of the predetermined function has been confirmed through the first actuation check process after the warning display is started.

The display control device may have a configuration further including an abnormality notification unit that performs first abnormality notification when the actuation check status recognition unit recognizes that the normal operation of the predetermined function has not been confirmed through the first actuation check process, and performs second abnormality notification different from the first abnormality notification when the actuation check status recognition unit recognizes that the normal operation of the predetermined function has been confirmed through the first actuation check process and recognizes that it has been confirmed that the option setting is unusable through the second actuation check process.

The display control device may have a configuration further including an option setting restriction notification unit that provides notification that use of the option setting is restricted when the actuation check status recognition unit recognizes that the normal operation of the predetermined function has been confirmed through the first actuation check process and recognizes that it has been confirmed that the option setting is unusable through the second actuation check process.

The display control device may have a configuration in which the movable object includes, as the predetermined function, a first predetermined function that executes the first actuation check process and the second actuation check process at start of the movable object, and a second predetermined function that executes at least the first actuation check process at the start of the movable object, and the warning display control unit starts the warning display for the first predetermined function and the warning display for the second predetermined function when the start operation recognition unit recognizes the start operation of the movable object, extends an end point of the warning display for the first predetermined function until the actuation check status recognition unit recognizes that the normal operation has been confirmed through the first actuation check process for the second predetermined function when the actuation check status recognition unit does not recognize that the normal operation of the second predetermined function has been confirmed through the first actuation check process for the second predetermined function when the actuation check status recognition unit recognizes that the normal operation of the first predetermined function has been confirmed through the first actuation check process for the first predetermined function, and finishes the warning display for the first predetermined function and the warning display for the second predetermined function at a point in time when the actuation check status recognition unit recognizes that the normal operation of the second predetermined function has been confirmed through the first actuation check process for the second predetermined function.

The display control device may have a configuration in which the movable object includes, as the predetermined function, a first predetermined function that executes the first actuation check process and the second actuation check process at start of the movable object, and a second predetermined function that executes at least the first actuation check process at the start of the movable object, and the warning display control unit starts the warning display for the first predetermined function and the warning display for the second predetermined function when the start operation recognition unit recognizes the start operation of the movable object, and finishes the warning display for the first predetermined function and the warning display for the second predetermined function at a point in time when the actuation check status recognition unit recognizes that the normal operation of the predetermined function has been confirmed through the first actuation check process for the second predetermined function when the actuation check status recognition unit does not recognize that the normal operation of the first predetermined function has been confirmed through the first actuation check process for the first predetermined function when the actuation check status recognition unit recognizes that the normal operation of the second predetermined function has been confirmed through the first actuation check process for the second predetermined function.

As a second aspect for achieving the above object, provided is a display control method to be executed by a computer to control actuation of a display device provided in a movable object, the display control method including: a start operation recognition step of recognizing a start operation of the movable object; an actuation check status recognition step of recognizing an execution status of an actuation check process for a predetermined function included in the movable object, the actuation check process being executed when the movable object is started; and a warning display control step of starting a warning display using the display device when the start operation recognition step recognizes the start operation of the movable object, and finishing the warning display based on the execution status of the actuation check process recognized by the actuation check status recognition step, in which when the actuation check process includes a first actuation check process of checking a normal operation of the predetermined function and a second actuation check process of checking whether option setting of the predetermined function is usable or unusable, the second actuation check process being executed after the first actuation check process checks the normal operation of the predetermined function, the warning display control step finishes the warning display at a point in time when the actuation check status recognition step recognizes that the normal operation of the predetermined function has been confirmed through the first actuation check process after the warning display is started.

The display control device and the display control method described above make it possible to reduce the time until the warning display displayed at the start of the movable object disappears, thereby reducing the feeling of anxiety of the user.

### BRIEF DESCRIPTION OF THE DRAWINGS

FIG. 1 is an explanatory diagram of a control mode of a display device by a display control device;

FIG. 2 is a configuration diagram of the display control device;

FIG. 3 is a flowchart of control of a warning display for ADAS;

FIG. 4 is a timing chart of the warning display for the ADAS;

FIG. 5 is a flowchart of control of waring displays for a plurality of target functions; and

FIG. 6 is a timing chart of the warning displays for the target functions.

### DETAILED DESCRIPTION OF THE INVENTION

### 1. Configuration of Display Control Device

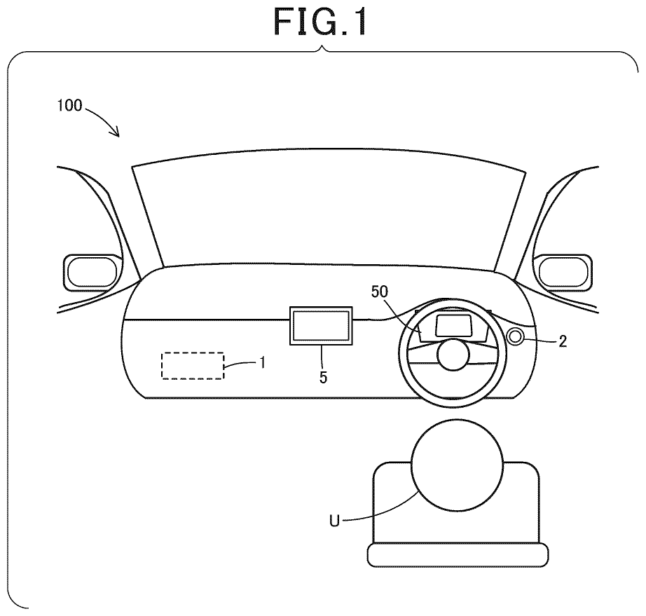

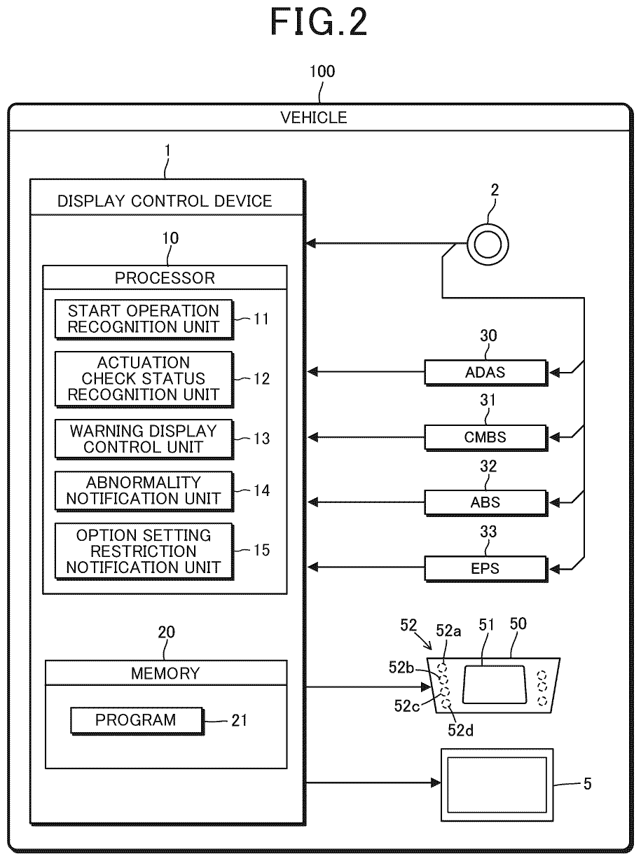

The configuration of a display control device 1 of the present disclosure will be described with reference to FIGS. 1 and 2. As shown in FIG. 1, the display control device 1 is mounted on a vehicle 100 and controls the actuation of a meter 50 and a center display 5 that are provided in the vehicle 100. The meter 50 is disposed in front of a driver's seat 3 of the vehicle 100. The vehicle 100 is provided with an SS (start/stop) switch 2 that is operated by a user U of the vehicle 100. The user U operates the SS switch 2 to start (power on) and stop (power off) the vehicle 100. The vehicle 100 corresponds to the movable object of the present disclosure. The movable object of the present disclosure may be, for example, a ship or an aircraft instead of the vehicle.

Referring to FIG. 2, the display control device 1 is connected to the SS switch 2, the center display 5, the meter 50, advanced driver-assistance systems (ADAS) 30, a collision mitigation brake system (CMBS) 31, an antilock braking system (ABS) 32, and an electric power steering (EPS) 33 that are provided in the vehicle 100.

The ADAS 30, the CMBS 31, the ABS 32, and the EPS 33 correspond to the predetermined function of the present disclosure. In addition, the ADAS 30 corresponds to the first predetermined function of the present disclosure for which the user U can make option setting (such as the setting of the distance to the preceding vehicle in adaptive cruise control), and the functions of the CMBS 31, the ABS 32, and the EPS 33 correspond to the second predetermined function of the present disclosure for which the user U cannot make option setting. Note that the predetermined function of the present disclosure is not limited to these functions and may be any function for which an actuation check of normal operation is performed at the start of the vehicle 100, such as oil or a battery.

The meter 50 includes a meter display 51 that displays the traveling state (such as the speed, travel distance, and fuel consumption) and the like of the vehicle 100, and a warning display unit 52 that displays warning for the functions included in the vehicle 100. The warning display unit 52 displays a warning display 52a for the ADAS 30, a warning display 52b for the CMBS 31, a warning display 52c for the ABS 32, and a warning display 52d for the EPS 33.

The display control device 1 is a control unit including a processor 10, a memory 20, and the like. The processor 10 functions as a start operation recognition unit 11, an actuation check status recognition unit 12, a warning display control unit 13, an abnormality notification unit 14, and an option setting restriction notification unit 15 by executing a program 21 stored in the memory 20.

The processor 10 corresponds to the computer of the present disclosure. A process to be executed by the start operation recognition unit 11 corresponds to the start operation recognition step in the display control method of the present disclosure, and a process to be executed by the actuation check status recognition unit 12 corresponds to the actuation check status recognition step in the display control method of the present disclosure. A process to be executed by the warning display control unit 13 corresponds to the warning display control step in the display control method of the present disclosure.

The start operation recognition unit 11 recognizes a start operation of the vehicle 100 using the SS switch 2 based on an operation signal input to the start operation recognition unit 11 from the SS switch 2. When the start operation of the vehicle 100 using the SS switch 2 is performed, the ADAS 30 executes an actuation check process to confirm that the function of the ADAS is actuated normally. Similarly, when the start operation of the vehicle 100 using the SS switch 2 is recognized, the CMBS 31, the ABS 32, and the EPS 33 also execute the actuation check process for each function.

The actuation check status recognition unit 12 recognizes the execution status of the actuation check process for each function of the ADAS 30, the CMBS 31, the ABS 32, and the EPS 33 through communication with the ADAS 30, the CMBS 31, the ABS 32, and the EPS 33. The warning display control unit 13 controls the display of the warning displays 52a to 52d for each function on the warning display unit 52 of the meter 50. The abnormality notification unit 14 performs abnormality notification for the ADAS 30, the CMBS 31, the ABS 32, and the EPS 33 through display on the meter display 51 and the center display 5. The option setting restriction notification unit 15 provides notification that option setting in the ADAS 30 is disabled through display on the center display 5.

### 2. Warning Display for ADAS

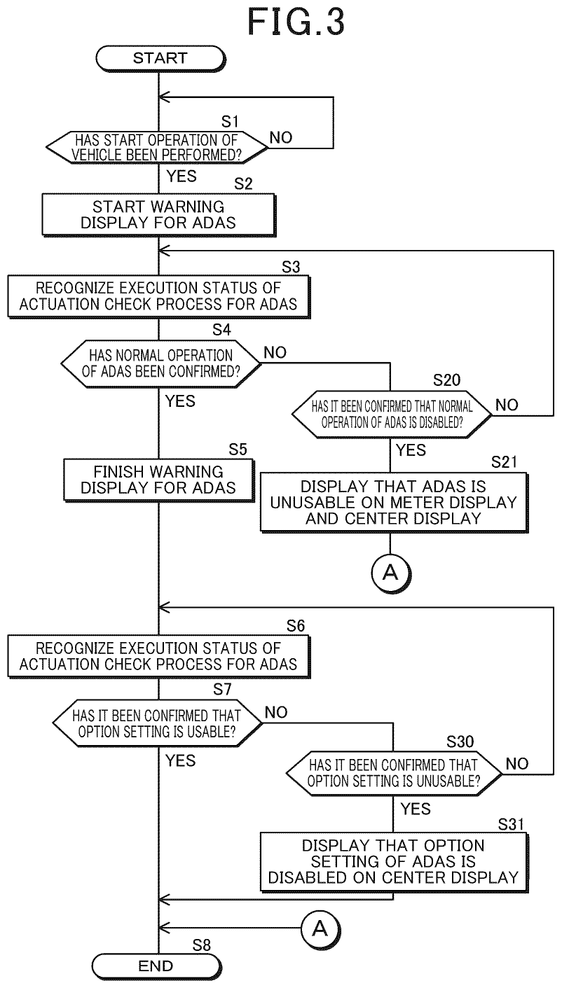

Display control of the warning display 52a for the ADAS 30 to be executed by the display control device 1 will be described in accordance with a flowchart shown in FIG. 3. In step S1 of FIG. 3, when the start operation recognition unit 11 recognizes the start operation of the vehicle 100 based on the operation signal of the SS switch 2, the process is advanced to step S2. In response to the start operation of the vehicle 100, the actuation check process for each function is started in the ADAS 30, the CMBS 31, the ABS 32, and the EPS 33.

In step S2, the warning display control unit 13 starts display of the warning display 52a for the ADAS 30 on the warning display unit 52 of the meter 50. In the following step S3, the actuation check status recognition unit 12 recognizes the execution status of the actuation check process in the ADAS 30 through communication with the ADAS 30.

In the next step S4, the warning display control unit 13 determines whether the actuation check status recognition unit 12 has recognized that the normal operation of the ADAS 30 has been confirmed. Then, the warning display control unit 13 advances the process to step S5 when the normal operation of the ADAS 30 has been confirmed and advances the process to step S20 when the normal operation of the ADAS 30 has not been confirmed.

In step S20, the warning display control unit 13 determines whether the actuation check status recognition unit 12 has confirmed that the normal operation of the ADAS 30 is disabled. Then, the warning display control unit 13 advances the process to step S21 when it has been confirmed that the normal operation of the ADAS 30 is disabled, and advances the process to step S3 when it has not been confirmed that the normal operation of the ADAS 30 is disabled.

In step S21, the abnormality notification unit 14 performs display providing notification that the ADAS 30 is unusable (corresponding to the first abnormality notification of the present disclosure) on the meter display 51 and the center display 5, and advances the process to step S8. In step S5, the warning display control unit 13 finishes the display of the warning display 52a for the ADAS 30.

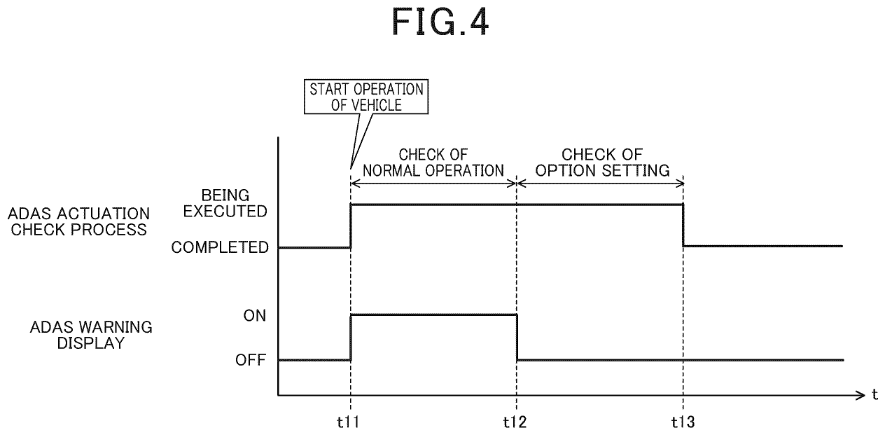

FIG. 4 is a timing chart showing the execution status of the actuation check process for the ADAS 30 and the display status of the warning display 52a for the ADAS 30 on a common time axis t. In FIG. 4, t11 is the point in time when the start operation of the vehicle 100 is performed, and the actuation check process for the ADAS 30 is started and the display of the warning display 52a for the ADAS 30 is started (display on). Then, at t12 when the check of the normal operation of the ADAS 30 is completed, the warning display control unit 13 finishes the display of the warning display 52a for the ADAS 30 (display off). The process of checking the normal operation of the ADAS 30 from t11 to t12 corresponds to the first actuation check process of the present disclosure, and the check of whether the option setting is usable or unusable from t12 to t13 corresponds to the second actuation check process of the present disclosure.

Accordingly, the timing at which the warning display 52a disappears can be made earlier than that in a case in which the display of the warning display 52a for the ADAS 30 is finished at t13 when the actuation check process for the ADAS 30 including the check of whether the option setting of the ADAS 30 is usable or unusable is completed. Thus, it is possible to reduce the feeling of anxiety of the user U caused by the warning display 52a not disappearing soon.

In the following step S6, the actuation check status recognition unit 12 recognizes the execution status of the actuation check process in the ADAS 30 through communication with the ADAS 30. In the next step S7, the abnormality notification unit 14 determines whether the actuation check status recognition unit 12 has confirmed that the option setting of the ADAS 30 is usable. Then, the abnormality notification unit 14 advances the process to step S8 when it has been confirmed that the option setting is usable, and advances the process to step S30 when it has not been confirmed that the option setting is usable.

In step S30, the abnormality notification unit 14 determines whether the actuation check status recognition unit 12 has confirmed that the option setting of the ADAS 30 is unusable. Then, the abnormality notification unit 14 advances the process to step S31 when it has been confirmed that the option setting is unusable, and advances the process to step S6 when it has not been confirmed that the option setting is unusable.

In step S31, the abnormality notification unit 14 performs display providing notification that the option setting of the ADAS 30 is unusable and the use of the option setting is restricted (corresponding to the second abnormality notification of the present disclosure) on the center display 5, and advances the process to step S8.

### 3. Warning Displays for a Plurality of Target Functions

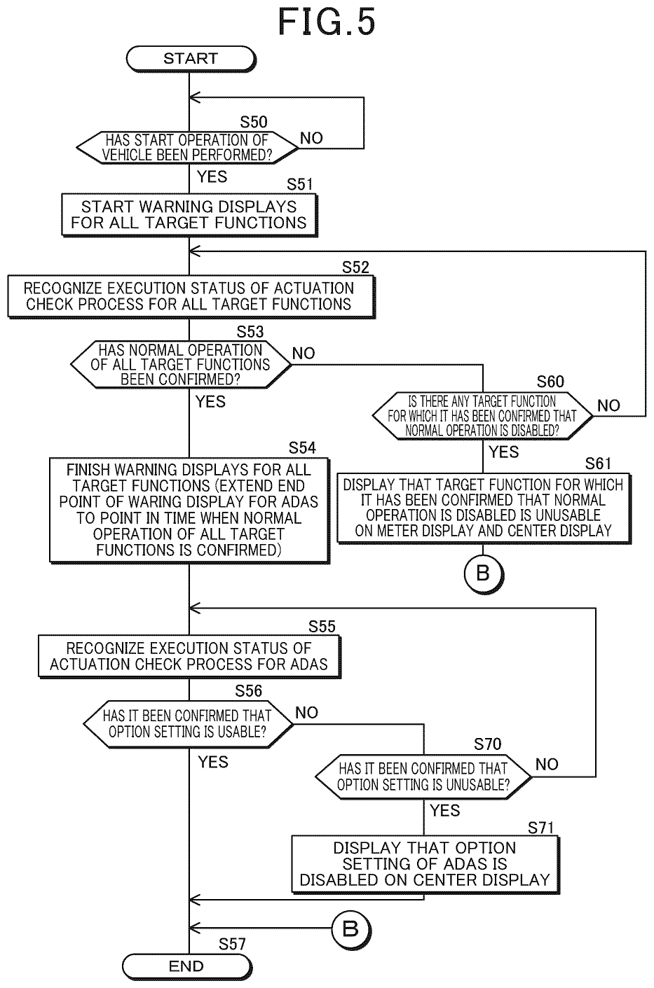

Control of the display end timing of the warning displays 52a to 52d to be executed by the display control device 1 will be described in accordance with a flowchart shown in FIG. 5. In step S50 of FIG. 5, when the start operation recognition unit 11 recognizes the start operation of the vehicle 100 based on the operation signal of the SS switch 2, the process is advanced to step S51. In response to the start operation of the vehicle 100, the actuation check process for each function is started in the ADAS 30, the CMBS 31, the ABS 32, and the EPS 33. Hereinbelow, the ADAS 30, the CMBS 31, the ABS 32, and the EPS 33 are also referred to as the target functions.

In step S51, the warning display control unit 13 starts display of all the warning displays 52a to 52d on the warning display unit 52 of the meter 50. In the following step S52, the actuation check status recognition unit 12 recognizes the execution status of the actuation check process for each function in the ADAS 30, the CMBS 31, the ABS 32, and the EPS 33 through communication with the ADAS 30, the CMBS 31, the ABS 32, and the EPS 33.

In the next step S53, the warning display control unit 13 determines whether the actuation check status recognition unit 12 has confirmed the normal operation for all of the ADAS 30, the CMBS 31, the ABS 32, and the EPS 33. Then, when the normal operation has been confirmed for all of the ADAS 30, the CMBS 31, the ABS 32, and the EPS 33, the warning display control unit 13 advances the process to step S54.

On the other hand, when the normal operation of all of the ADAS 30, the CMBS 31, the ABS 32, and the EPS 33 has not been confirmed, the warning display control unit 13 advances the process to step S60. In step S60, the abnormality notification unit 14 determines whether there is any target function for which the actuation check status recognition unit 12 has confirmed that the normal operation is disabled. Then, the abnormality notification unit 14 advances the process to step S61 when there is a target function for which it has been confirmed that the normal operation is disabled, and advances the process to step S52 when there is no target function for which it has been confirmed that the normal operation is disabled.

In step S61, the abnormality notification unit 14 performs display providing notification that the target function for which it has been recognized that the normal operation is disabled is unusable (corresponding to the first abnormality notification of the present disclosure) on the meter display 51 and the center display 5, and advances the process to step S57. In step S54, the warning display control unit 13 finishes the display of the warning displays 52a to 52d for all the target functions.

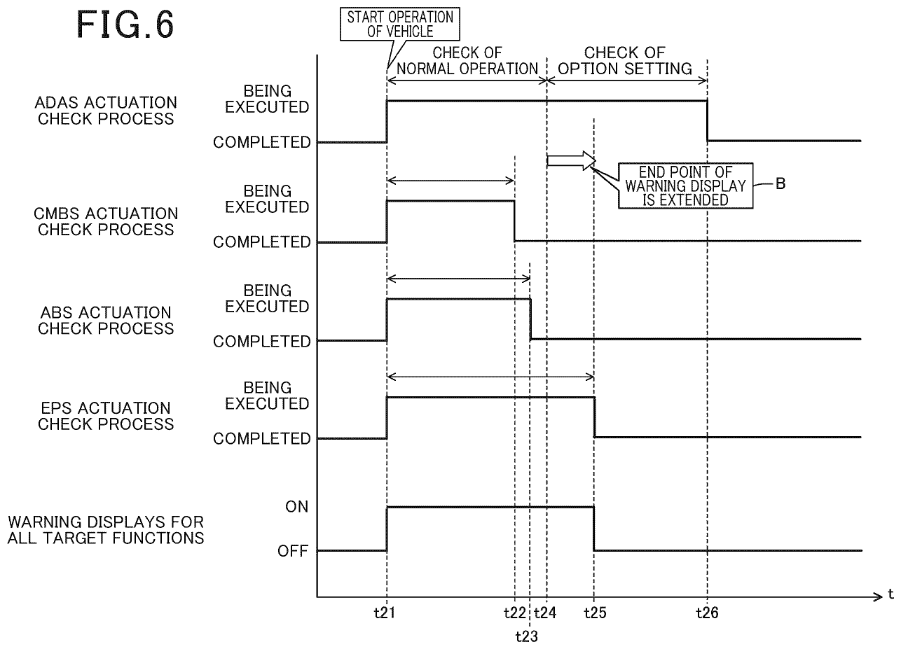

FIG. 6 is a timing chart showing the progress status of the actuation check process for the target functions and the display status of all the warning displays 52a to 52d on a common time axis. In FIG. 6, t21 is the point in time when the start operation of the vehicle 100 is performed, and the actuation check process for each target function is started and display of all the warning displays 52a to 52d is started (display on).

Then, at t25 when the check of the normal operation is completed for all the target functions through the actuation check process, the warning display control unit 13 finishes the display of all the warning displays 52a to 52d. Accordingly, as indicated by speech bubble B, the end point of the display of the warning display 52a for the ADAS 30 is extended from t24 when the check of the normal operation of the ADAS 30 is completed to t25 when the check of the normal operation of all the target functions is completed, and the start and end of the display are performed at the same timing for all the warning displays 52a to 52d. Thus, it is possible to reduce the feeling of annoyance of the user U caused by flickering due to differences in the timing of the start and end of display between the warning displays 52a to 52d.

In the following step S55, the actuation check status recognition unit 12 recognizes the execution status of the actuation check process in the ADAS 30 through communication with the ADAS 30. In the next step S56, the abnormality notification unit 14 determines whether the actuation check status recognition unit 12 has confirmed that the option setting of the ADAS 30 is enabled. Then, the abnormality notification unit 14 advances the process to step S57 when it has been confirmed that the option setting is usable, and advances the process to step S70 when it has not been confirmed that the option setting is usable.

In step S70, the abnormality notification unit 14 determines whether the actuation check status recognition unit 12 has confirmed that the option setting of the ADAS 30 is unusable. Then, the abnormality notification unit 14 advances the process to step S71 when it has been confirmed that the option setting is unusable, and advances the process to step S55 when it has not been confirmed that the option setting is unusable.

In step S71, the abnormality notification unit 14 performs display providing notification that the option setting of the ADAS 30 is unusable and the use of the option setting is restricted (corresponding to the second abnormality notification of the present disclosure) on the center display 5, and advances the process to step S57.

### 4. Other Embodiments

In the above embodiment, the abnormality notification unit 14 is provided to distinguish between abnormality notification in a case in which the normal operation of the predetermined function has not been confirmed and abnormality notification in a case in which the normal operation of the predetermined function has been confirmed but it has not been confirmed that the option setting is usable. As another embodiment, a configuration in which the abnormality notification unit 14 is omitted may be employed.

In the above embodiment, the option setting restriction notification unit 15 is provided to provide notification that the use of the option setting is restricted when it is confirmed that the option setting is unusable. However, a configuration in which the option setting restriction notification unit 15 is omitted may be employed.

In the above embodiment, as shown in FIGS. 5 and 6, the warning display control unit 13 executes the process of reducing flickering of the warning displays 52a to 52d by setting the timings for finishing the display of the warning displays 52a to 52d to the same point in time. As another embodiment, a configuration that does not execute such a process may be employed.

Note that FIG. 2 is a schematic diagram showing the configuration of the display control device 1 divided in accordance with main processing details to facilitate understanding of the invention of the present application. The configuration of the display control device 1 may be configured with other divisions. In addition, the process of each element may be executed by one hardware unit or by a plurality of hardware units. Furthermore, the process of each element shown in FIGS. 3 and 5 may be executed by one program or by a plurality of programs.

### 5. Configurations Supported by Embodiment

The above embodiment is a specific example of the following configurations.

(Configuration 1) A display control device that controls actuation of a display device provided in a movable object, the display control device including: a start operation recognition unit that recognizes a start operation of the movable object; an actuation check status recognition unit that recognizes an execution status of an actuation check process for a predetermined function included in the movable object, the actuation check process being executed when the movable object is started; and a warning display control unit that starts a warning display using the display device when the start operation recognition unit recognizes the start operation of the movable object, and finishes the warning display based on the execution status of the actuation check process recognized by the actuation check status recognition unit, in which when the actuation check process includes a first actuation check process of checking a normal operation of the predetermined function and a second actuation check process of checking whether option setting of the predetermined function is usable or unusable, the second actuation check process being executed after the first actuation check process checks the normal operation of the predetermined function, the warning display control unit finishes the warning display at a point in time when the actuation check status recognition unit recognizes that the normal operation of the predetermined function has been confirmed through the first actuation check process after the warning display is started.

With the display control device of configuration 1, by finishing the warning display that is started when the movable object is started at the point in time when the normal operation of the predetermined function is confirmed, it is possible to reduce the feeling of anxiety of the user caused by an increase in the time until the warning display disappears.

(Configuration 2) The display control device according to configuration 1, further including an abnormality notification unit that performs first abnormality notification when the actuation check status recognition unit recognizes that the normal operation of the predetermined function has not been confirmed through the first actuation check process, and performs second abnormality notification different from the first abnormality notification when the actuation check status recognition unit recognizes that the normal operation of the predetermined function has been confirmed through the first actuation check process and recognizes that it has been confirmed that the option setting is unusable through the second actuation check process.

With the display control device of configuration 2, it is possible to make the user recognize an abnormality in the operation itself of the predetermined function and an abnormality in the option setting distinguished from each other.

(Configuration 3) The display control device according to configuration 1 or 2, further including an option setting restriction notification unit that provides notification that use of the option setting is restricted when the actuation check status recognition unit recognizes that the normal operation of the predetermined function has been confirmed through the first actuation check process and recognizes that it has been confirmed that the option setting is unusable through the second actuation check process.

With the display control device of configuration 3, it is possible to make the user recognize that the use of the predetermined function is restricted to use without option setting.

(Configuration 4) The display control device according to any one of configurations 1 to 3, in which the movable object includes, as the predetermined function, a first predetermined function that executes the first actuation check process and the second actuation check process at start of the movable object, and a second predetermined function that executes at least the first actuation check process at the start of the movable object, and the warning display control unit starts the warning display for the first predetermined function and the warning display for the second predetermined function when the start operation recognition unit recognizes the start operation of the movable object, extends an end point of the warning display for the first predetermined function until the actuation check status recognition unit recognizes that the normal operation has been confirmed through the first actuation check process for the second predetermined function when the actuation check status recognition unit does not recognize that the normal operation of the second predetermined function has been confirmed through the first actuation check process for the second predetermined function when the actuation check status recognition unit recognizes that the normal operation of the first predetermined function has been confirmed through the first actuation check process for the first predetermined function, and finishes the warning display for the first predetermined function and the warning display for the second predetermined function at a point in time when the actuation check status recognition unit recognizes that the normal operation of the second predetermined function has been confirmed through the first actuation check process for the second predetermined function.

With the display control device of configuration 4, by starting and stopping the warning displays for the first predetermined function and the second predetermined function at the same timing when the movable object is started, it is possible to reduce the user's perception of flickering in the warning displays.

(Configuration 5) The display control device according to any one of configurations 1 to 4, in which the movable object includes, as the predetermined function, a first predetermined function that executes the first actuation check process and the second actuation check process at start of the movable object, and a second predetermined function that executes at least the first actuation check process at the start of the movable object, and the warning display control unit starts the warning display for the first predetermined function and the warning display for the second predetermined function when the start operation recognition unit recognizes the start operation of the movable object, and finishes the warning display for the first predetermined function and the warning display for the second predetermined function at a point in time when the actuation check status recognition unit recognizes that the normal operation of the predetermined function has been confirmed through the first actuation check process for the second predetermined function when the actuation check status recognition unit does not recognize that the normal operation of the first predetermined function has been confirmed through the first actuation check process for the first predetermined function when the actuation check status recognition unit recognizes that the normal operation of the second predetermined function has been confirmed through the first actuation check process for the second predetermined function.

With the display control device of configuration 5, by starting and stopping the warning displays for the first predetermined function and the second predetermined function at the same timing when the movable object is started, it is possible to reduce the user's perception of flickering in the warning displays.

(Configuration 6) A display control method to be executed by a computer to control actuation of a display device provided in a movable object, the display control method including: a start operation recognition step of recognizing a start operation of the movable object; an actuation check status recognition step of recognizing an execution status of an actuation check process for a predetermined function included in the movable object, the actuation check process being executed when the movable object is started; and a warning display control step of starting a warning display using the display device when the start operation recognition step recognizes the start operation of the movable object, and finishing the warning display based on the execution status of the actuation check process recognized by the actuation check status recognition step, in which when the actuation check process includes a first actuation check process of checking a normal operation of the predetermined function and a second actuation check process of checking whether option setting of the predetermined function is usable or unusable, the second actuation check process being executed after the first actuation check process checks the normal operation of the predetermined function, the warning display control step finishes the warning display at a point in time when the actuation check status recognition step recognizes that the normal operation of the predetermined function has been confirmed through the first actuation check process after the warning display is started.

By executing the display control method of configuration 6 using a computer, it is possible to obtain the same action and effects as the display control device of configuration 1.

### REFERENCE SIGNS LIST

1 display control device
2 SS switch
5 center display
10 processor
11 start operation recognition unit
12 actuation check status recognition unit
13 warning display control unit
14 abnormality notification unit
15 option setting restriction notification unit
20 memory
21 program
30 ADAS
31 CMBS
32 ABS
33 EPS
50 meter
51 meter display
52 warning display unit
52a to 52d warning display
U user

1. A display control device that controls actuation of a display device provided in a movable object, the display control device comprising:
a start operation recognition unit that recognizes a start operation of the movable object;
an actuation check status recognition unit that recognizes an execution status of an actuation check process for a predetermined function included in the movable object, the actuation check process being executed when the movable object is started; and
a warning display control unit that starts a warning display using the display device when the start operation recognition unit recognizes the start operation of the movable object, and finishes the warning display based on the execution status of the actuation check process recognized by the actuation check status recognition unit, wherein
when the actuation check process includes a first actuation check process of checking a normal operation of the predetermined function and a second actuation check process of checking whether option setting of the predetermined function is usable or unusable, the second actuation check process being executed after the first actuation check process checks the normal operation of the predetermined function, the warning display control unit finishes the warning display at a point in time when the actuation check status recognition unit recognizes that the normal operation of the predetermined function has been confirmed through the first actuation check process after the warning display is started.

2. The display control device according to claim 1, further comprising an abnormality notification unit that performs first abnormality notification when the actuation check status recognition unit recognizes that the normal operation of the predetermined function has not been confirmed through the first actuation check process, and performs second abnormality notification different from the first abnormality notification when the actuation check status recognition unit recognizes that the normal operation of the predetermined function has been confirmed through the first actuation check process and recognizes that it has been confirmed that the option setting is unusable through the second actuation check process.

3. The display control device according to claim 1, further comprising an option setting restriction notification unit that provides notification that use of the option setting is restricted when the actuation check status recognition unit recognizes that the normal operation of the predetermined function has been confirmed through the first actuation check process and recognizes that it has been confirmed that the option setting is unusable through the second actuation check process.

4. The display control device according to claim 1, wherein
the movable object includes, as the predetermined function, a first predetermined function that executes the first actuation check process and the second actuation check process at start of the movable object, and a second predetermined function that executes at least the first actuation check process at the start of the movable object, and
the warning display control unit starts the warning display for the first predetermined function and the warning display for the second predetermined function when the start operation recognition unit recognizes the start operation of the movable object, extends an end point of the warning display for the first predetermined function until the actuation check status recognition unit recognizes that a normal operation has been confirmed through the first actuation check process for the second predetermined function when the actuation check status recognition unit does not recognize that the normal operation of the second predetermined function has been confirmed through the first actuation check process for the second predetermined function when the actuation check status recognition unit recognizes that the normal operation of the first predetermined function has been confirmed through the first actuation check process for the first predetermined function, and finishes the warning display for the first predetermined function and the warning display for the second predetermined function at a point in time when the actuation check status recognition unit recognizes that the normal operation of the second predetermined function has been confirmed through the first actuation check process for the second predetermined function.

5. The display control device according to claim 1, wherein
the movable object includes, as the predetermined function, a first predetermined function that executes the first actuation check process and the second actuation check process at start of the movable object, and a second predetermined function that executes at least the first actuation check process at the start of the movable object, and
the warning display control unit starts the warning display for the first predetermined function and the warning display for the second predetermined function when the start operation recognition unit recognizes the start operation of the movable object, and finishes the warning display for the first predetermined function and the warning display for the second predetermined function at a point in time when the actuation check status recognition unit recognizes that the normal operation of the predetermined function has been confirmed through the first actuation check process for the second predetermined function when the actuation check status recognition unit does not recognize that the normal operation of the first predetermined function has been confirmed through the first actuation check process for the first predetermined function when the actuation check status recognition unit recognizes that the normal operation of the second predetermined function has been confirmed through the first actuation check process for the second predetermined function.

6. A display control method to be executed by a computer to control actuation of a display device provided in a movable object, the display control method comprising:
a start operation recognition step of recognizing a start operation of the movable object;
an actuation check status recognition step of recognizing an execution status of an actuation check process for a predetermined function included in the movable object, the actuation check process being executed when the movable object is started; and
a warning display control step of starting a warning display using the display device when the start operation recognition step recognizes the start operation of the movable object, and finishing the warning display based on the execution status of the actuation check process recognized by the actuation check status recognition step, wherein
when the actuation check process includes a first actuation check process of checking a normal operation of the predetermined function and a second actuation check process of checking whether option setting of the predetermined function is usable or unusable, the second actuation check process being executed after the first actuation check process checks the normal operation of the predetermined function, the warning display control step finishes the warning display at a point in time when the actuation check status recognition step recognizes that the normal operation of the predetermined function has been confirmed through the first actuation check process after the warning display is started.
